(19) United States
(12) Patent Application Publication
(10) Pub. No.: US 2012/0151031 A1
(43) Pub. Date: Jun. 14, 2012

(54) REAL-TIME, SELF-DIRECTING UPDATING OF ASSET STATE

(76) Inventors: Venkateswaran Karuppanan, Morristown, NJ (US); Herbert Perten, Suffern, NY (US); Thomas A. Robinson, Mendham, NJ (US); Timothy P. Slifkin, Morristown, NJ (US)

(21) Appl. No.: 12/952,198

(22) Filed: Nov. 22, 2010

Related U.S. Application Data
(63) Continuation of application No. 11/611,838, filed on Dec. 15, 2006, now abandoned.
(60) Provisional application No. 60/750,498, filed on Dec. 15, 2005.

(51) Int. Cl. G06F 15/173

(52) U.S. Cl. 709/224

(57) ABSTRACT

A system allows a remote asset, via an Intelligent Device and interconnected Central Data Server to autonomously, and continuously monitor and update its status on various parameters; and from these, to calculate an overall asset state that may be caused by various combinations of the parameters.

### RELATED APPLICATIONS

This is a continuation of U.S. application Ser. No. 11/611,838 filed 15 Dec. 2006 Applicants claim the benefit of U.S. application Ser. No. 60/750,498 filed Dec. 15, 2005. This application is related to U.S. application Ser. No. 60/750,498 filed Dec. 15, 2005. The contents of these application are incorporated in this application as if fully recited herein.

### FIELD OF THE INVENTION

This invention relates to determining and updating of state of assets at various locations, and particularly but not exclusively to freight assets.

### BACKGROUND OF THE INVENTION

Current practice involves a human operator who must determine overall asset state manually, or requires passing data to a central server and such overall asset state determination is made on the server itself by an operator.

An object of the invention is to improve asset state determination and updating.

### SUMMARY OF EMBODIMENTS OF THE INVENTION

According to an embodiment of the invention, a system allows a remote asset, via an Intelligent Device and interconnected Central Data Server (“data server”) to autonomously, and continuously monitor and update its status on various parameters.

These and other aspect of the invention are pointed out in the claims forming a part of this specification. Other objects and advantages of the invention will become evident from the following detailed description when read in light of the following drawings.

### BRIEF DESCRIPTION OF THE DRAWINGS

FIG. 1 is diagram of a system embodying aspects of the invention.

FIG. 2 is a block diagram illustrating details of one of the assets of FIG. 1 and embodying aspects of the invention.

FIG. 3 is a diagram illustrating use of the system in FIG. 1, FIG. 2, and FIG. 3.

FIG. 4 is a diagram depicting steps performed by the system of FIG. 1, FIG. 2, and FIG. 3 and embodying aspects of the invention.

### DETAILED DESCRIPTION OF PREFERRED EMBODIMENTS

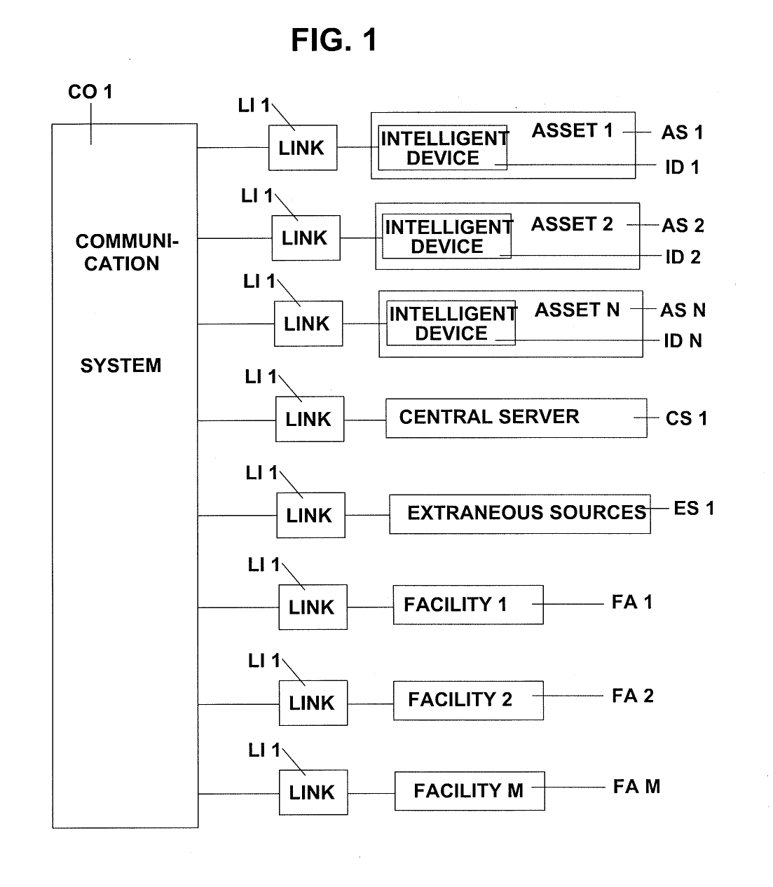

In the system of FIG. 1, a communication system CO1 establishes communication, via links LI1, between a central server CS1 and intelligent devices ID1, ID2, . . . IDN in N assets AS1, AS2, . . . ASN, and extraneous sources ES1, and M number of facilities FA1, FA2, . . . FAM. According to embodiments of the invention, the links LI1 and the communication system CS1 includes one or more of available arrangements, such as telephone land lines, wireless systems, satellite communications, Internet services, radio signals, etc. The assets AS1, AS2, . . . ASN include any one or more of stationary or moving devices, such as a train car, a bus, a truck, airplane, etc. For simplicity the reference characters ID1, ID2, . . . IDN are referred to collectively as IDx, the reference characters AS1, AS2, . . . ASN as ASx, and the reference characters FA1, FA2, . . . FAM as FAx.

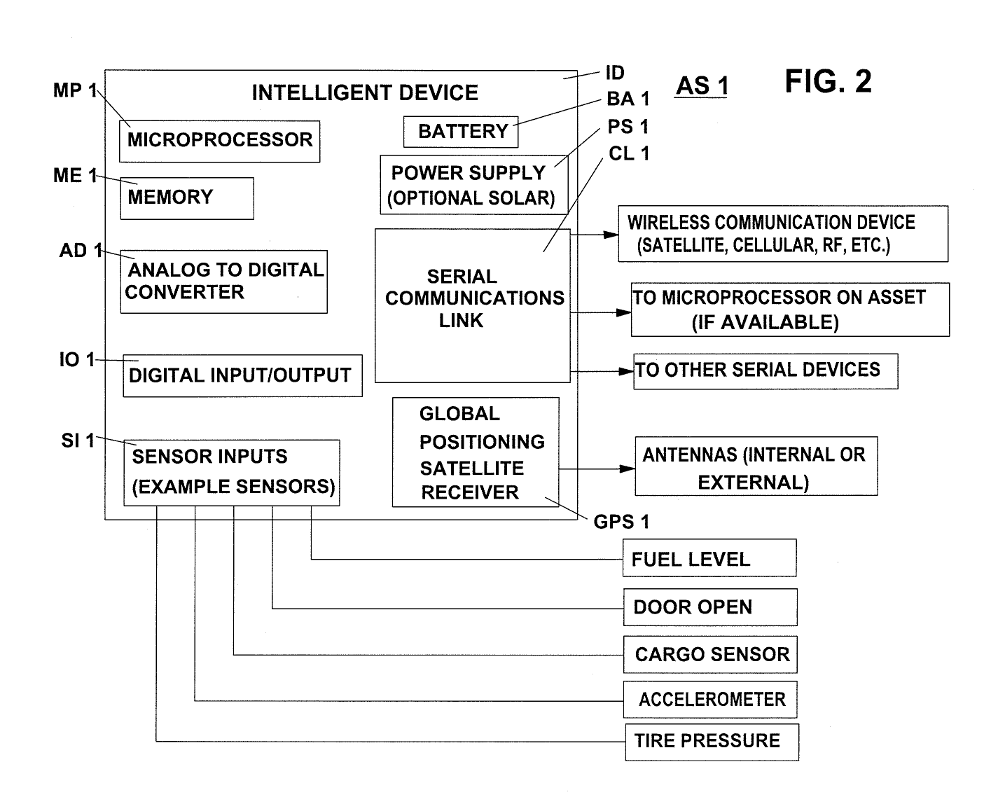

Details of the intelligent devices IDx appear in FIG. 2. Each IDx includes an interconnected system of a battery BA1 and/or power supply PS1 (optional solar) that powers a microprocessor MP1, a memory ME1 coupled to the microprocessor, an analog to digital converter AD1, a digital input/output IO1, sensor inputs SI1 (for example sensors), a serial communications link CL1, and a global positioning satellite receiver GPS1. These elements are all interconnected as necessary.

The sensors in the sensor inputs SI1 receive data from the asset ASx carrying the device IDx. According to embodiments of the invention, the sensor inputs SI1 receive, from the asset ASx, data representing the asset fuel level, whether a door in the asset is open, the weight of any cargo, accelerometer outputs from movements of the vehicle, tire pressures, etc. These are only samples of the possible input and other inputs are considered as embodiments of the invention.

The serial communications link CL1 outputs signals to one or more of a link LI1 (designated “wireless communications device (satellite, cellular, RF, etc.)” in FIG. 2), another microprocessor on the asset AS1 (if available on the asset), other serial devices, and antennas (internal or external).

According to embodiments of this invention each remote asset ASx operates, via an Intelligent Devices IDx and interconnected Central Server or Central Data Server CSx (“data server”), 1) to autonomously, and continuously monitor and update its status on various parameters or conditions which pertain to the asset ASx; 2) from these, to calculate an overall asset state created by one or more of various combinations of the parameters; 3) to provide near-real-time updates to the central server CSx that is connected to various information distribution paths; and 4) to accept communication from the central data server CSx which may provide additional information to the asset allowing it to further modify its state. Further, the central server CSx itself serves 5) to provide additional parameter information from other sources (such as industry standard “Electronic Data Interchange messages”); 6) to instantly and autonomously modify its state table to denote all parameters effected by a change in any single parameter; 7) to download new state information to the asset via wireless or wired links LI1; 8) then to allow, via the communication system CO1 in the form of one or more of Internet or similar network connection, any authorized user to access the system and determine the state of any asset in the population, regardless of geographic location.

According to embodiments of the invention, the assets ASx may be located in any of similar or radically different locations, interconnected by multiple wired or wireless communication links (i.e. local RF in a yard or on a ship, satellite and/or cellular over wider distances) and may have an unlimited number of parameters and or conditions associated with their status. This then allows any authorized user immediately to ascertain (via communication with a web-enabled application over the Internet for example) the status of any asset ASx in the fleet, regardless of its geographic location.

Each asset AS1 includes an Intelligent Device, which is connected via wireless (i.e. satellite, cellular, RF or other) or wired link to any of several reporting points. The data is collated and sent with the communication system CSx, via appropriate means (Internet, or other communications mechanism) to a central database in the central server CS1. From there, it is delivered to any number of users for viewing.

According to embodiments of the invention the wireless intelligent devices IDx and the associated equipment including the central server CS1 automatically causes a freight asset ASx to assume a pre-defined “conventional freight state”, based solely or substantially on its self-monitored condition (which may include data received over the communication system CS1, for example via a wireless LI1). This is in contrast to current practice wherein a human operator must determine overall all asset state manually, or where data is passed to a central server and such determination is made on the server itself by an operator.

For example, by virtue of its sensor inputs SI1, its GPS, and other inputs of the intelligent device IDx including communication from the communication system CO1, an asset ASx will “know”, i.e. have data as to, its relative location, that it is out of fuel, that it requires a diagnostics check, that it is currently not connected to any other asset, and that it's tire pressure is low, or other measured condition. As a result of the asset's “knowing” the state of these various parameters, it also “knows”—and can signal to the central server CS1—a specific state that may be assessed via evaluation of all these parameters. i.e., it will “know” that it is “Not Available for Service”. Once all of these parameters are brought into compliance (i.e. fuel loaded, pre-trip completed, and tire pressure adjusted), the asset will then “know” autonomously, that its state has changed to “Ready for Service” and it will send the appropriate message to the central server. All inventory values (Yard, Regional, units awaiting fueling, etc.) will thus be updated automatically. Note that this state change, based on continued autonomous updating of a variety of parameters, can be arrived at either by the Intelligent Device IDx on the asset ASx, or by the central server CS1 based on appropriate data.

The state transition from “Not Ready for Service” to “Ready for Service” is accomplished autonomously by the central server CS1 and/or the Intelligent Device IDx on the asset Asx, based on information gathered from local sensor inputs SI1 and via wireless links LI1 and the communication system CS1. No human intervention is required for the asset to change its state.

As an example, a refrigerated trailer entering a yard facility would use the GPS unit GPS1 (built into the device IDx) and compare it with “geofence” locations stored internally on the device IDx. It would then “know” that it had arrived at the facility FAx and send a notification over its wireless link LI1 to the central server CS1. According to embodiments of the invention this is performed without human intervention. The system, upon receiving the notification of entry to the yard from that trailer, would then instantly and autonomously update the status of that particular trailer so that appropriate personnel would know that it was no in the yard and ready to be unloaded.

According to embodiments of the invention, the asset ASx uses other detailed information, such as battery voltage, fuel on board, loaded/empty status, tire pressure, etc. to determine its current state. It sends data on its state, and the related parameters, instantly and continuously to the central server CS1 whenever an appropriate change occurs (as determined by the control device). This results in a “matrix” of information, which changes constantly based on information sent from each remote asset ASx by the control device, and without human intervention.

According to embodiments of the invention, autonomous processes maintain and update any combination of asset parameters. For example, all assets ASx requiring refueling at each facility can become instantly visible to pool personnel. Any assets ASx requiring maintenance can likewise become visible to appropriate maintenance personnel.

According to an embodiment of the invention data is viewed from several perspectives. If for example, an asset ASx leaves the yard in Newark enroute for a yard in Philadelphia, the yard Manager in Newark will immediately see his inventory decrease by one asset. The New York Region manager will also see his inventory decrease by one. Any related viewers (i.e. Maintenance Supervisor, etc.) will see the inventory of their relevant assets decrease by one within that yard and region. Then, when the asset gets to Philadelphia, the inventory in that yard will automatically increase by one. Thus, the assets ASx are directly driving the changes in all status elements across the entire population in real time and without human intervention.

According to embodiments of the invention, web-enabled, user-directed report filter based on multiple parameters, which allows quick overview of any assets ASx meeting criterion established by the user. For example, a “Ready Assets” filter would show only those assets for which all relevant parameters were in the appropriate state (i.e. fuel full, no maintenance, tire pressure OK, pre-trip successfully completed, etc.) This allows the user a method for quickly evaluating final status, which could be based on a large number of parameters. Due to the Web nature of the solution, this feature can be implemented by any authorized user in any geographic location, and may provide status on any asset in the population, regardless of physical location.

In this manner, a very large fleet of assets Asx (such as refrigerated trailers or containers) in multiple geographical locations, all provide updated information to the database server CS1 as it occurs autonomously and without human intervention. Thus, the dispatcher is viewing constantly updated data generated autonomously by the individual assets.

According to embodiments of the invention User-settable filters at the server CS1 provide classification into defined Conditions based on the status of a variety of parameters—each of which is determined by the asset via on-board intelligence and/or by the server itself autonomously.

According to embodiments of the invention, information is sent from an Asset ASx to a remote device, such as to the driver of the vehicle planning to move the asset via an appropriate wireless or wired device. The driver is then assured that the asset he is planning to move is, in fact, ready for movement.

The invention has a number of advantages, for example:
1. Assets ASx can autonomously determine (and modify) its current state by reading various parameters—either directly through sensors or through wireless or wired communications links. No human intervention is required.
2. Assets autonomously drive update of parameters in the central server system as appropriate (i.e. no polling is required).
3. The server CS1 itself can also autonomously update the state of any asset based on its reading of a variety of parameters, some of which will have come from the Intelligent Device on the asset, and some may have come from other sources (i.e. Industry 322 messages or specific operator inputs).
4. All relevant inventory records adjusted automatically and in real time at the server and, optionally, on the Intelligent Device IDx on the asset ASx as well.
5. The individual asset can change its state autonomously based on information from multiple sensors and sources.
6. Decisions regarding change of state can be done on the asset via its on-board Intelligence Device, and/or by the central server.
7. User-settable filters at the server allow classification into defined Conditions based on the status of a variety of parameters—each of which is determined by the asset via on-board intelligence and/or by the server itself autonomously.
8. Entire system is fully self-modifying without human intervention, and over various communications link such that no specific actions are required by personnel to capture current status of all parameters and, more importantly, overall State of the asset (i.e. Ready for Deployment).
9. All related states are changed as appropriate.
10. This information can be sent from the Asset to a remote device, such as to the driver of the vehicle planning to move the asset via an appropriate wireless or wired device. This allows the driver to be assured that the asset he is planning to move is, in fact, ready for movement.

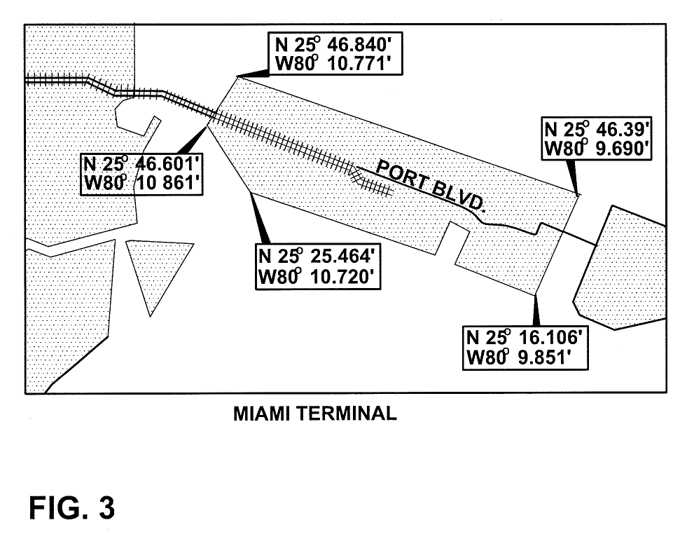

FIG. 3 illustrates a terminal such as the Miami terminal to illustrate endpoint of a region. Endpoints of a region, such as a facility FAx like a shipping yard, can be used to denote a geofence location. The system denotes “In” or “Out” based on the asset's location within the perimeter. This then becomes one of the states. Likewise, location within a smaller area within the yard (such as a fueling or loading dock) can also be calculated by the device IDx on asset ASx and used to autonomously update its state.

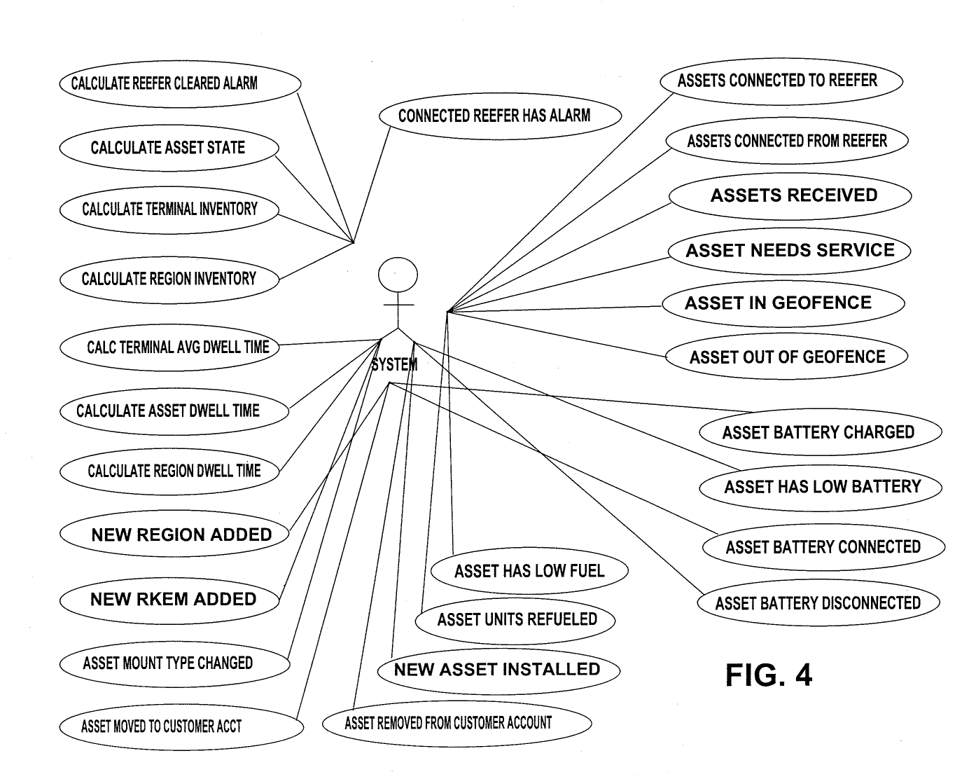

FIG. 4 illustrates an aspect of the operation involving some of the parameters. This illustrates of some of the parameters the Intelligent Device IDx, with which the server CSx can monitor and react with autonomously. There is no apparent order to the process as it is continuous and ad hoc. Any device can autonomously and instantly change its state from information received from its sensors, or via its wireless or wired links LI1. Thus, when fueling for that particular asset ASx is complete, it then instantly and autonomously updates its state, and then relays its new state information to the central server CS1. When a user completes a load operation, the central server CS1 can compare the other parameters of the asset to determine its final state (i.e. ready for shipment). There is no need for the central server CS1 to coordinate the process, nor to query each asset ASx periodically in order to maintain a current inventory and state table of all assets, regardless of geographic location. Effectively, the central server CS1 keeps accurate and current inventory and state table via autonomous communication from each of the assets in the entire population. Any view looking at any report will be immediately updated so that the report he is currently viewing is always current.

According to other embodiments of the invention, the Intelligent Device IDx has the means to make most determinations autonomously. In addition to its own sensors, it can also read the microprocessor attached to the asset ASx (if available) to capture information directly from the asset ASx as well. Further, the attached GPS unit allows the Intelligent Device IDx to know where it is geographically, and to determine any appropriate state conditions that are related to location. Internal processing of this data and sensor input allows the Intelligent Device IDx to make a determination as to state of the asset, and then send that updated State information directly to the central server via any one of several communications channels (wireless or wired) in the communication system CO1. The central server CS1 can then evaluate other data relevant to the asset Asx that has come into the system from other channels (i.e. load operation complete) and adjust the state table to reflect the correct state across a number of inventory parameters.

While embodiments of the invention have been described in detail, it will be evident to those skilled in the art that the invention may be embodied otherwise without departing from its spirit and scope.

What is claimed is:

1. A system, comprising:
a remote asset having via an intelligent device for autonomously, and continuously monitor and update its status on various parameters; and
an interconnected central data server to calculate an overall asset state that may be caused by various combinations of the parameters monitored by the intelligent device.

2. A method, comprising:
with an intelligent device for autonomously and continuously monitoring and updating its status on various parameters of a remote asset; and
with an interconnected central data server calculating an overall asset state that may be caused by various combinations of the parameters monitored by the intelligent device.
